(19) United States
(12) Patent Application Publication
(10) Pub. No.: US 2008/0096033 A1
(43) Pub. Date: Apr. 24, 2008

(54) Curable Composition, Cured Layer, and Laminate

(75) Inventors: Noriyasu Shinohara, Tokyo (JP); Ryousuke Iinuma, Tokyo (JP); Jiro Ueda, Tokyo (JP); Takayoshi Tanabe, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, TOKYO (JP)

(21) Appl. No.: 11/576,166

(22) PCT Filed: Oct. 14, 2005
(86) PCT No.: PCT/NL05/00741

§ 371 Date: Mar. 28, 2007

(30) Foreign Application Priority Data
Oct. 28, 2004 (JP) 2004-314342

(51) Int. Cl. C08L 33/02

(52) U.S. Cl. 428/500; 525/209

(57) ABSTRACT

To provide a curable a composition exhibiting excellent applicability and capable of forming a coating having high hardness, low curling properties, and excellent flexibility on the surface of a substrate, and a cured film including a cured product of the composition. A curable composition comprising: (A) 30 to 80 wt % of metal oxide particles to which an organic compound containing a polymerizable unsaturated group is bonded, and (B) 5 to 50 wt % of a urethane (meth)acrylate having an aromatic cyclic structure in the molecule and including three or more (meth)acryloyl groups, provided that the total amount of the composition excluding an organic solvent is 100 wt %; and a cured layer formed by curing the composition, and a laminate.

The present invention relates to a curable composition, a cured layer of the curable composition, and a laminate. More particularly, the present invention relates to a curable composition exhibiting excellent applicability and which is capable of forming a coating (film) having high hardness and exhibiting excellent scratch resistance and adhesion to the adjacent layer such as a substrate or a high-refractive-index layer on the surface of a substrate such as plastic (e.g. polycarbonate, polymethyl methacrylate, polystyrene, polyester, polyolefin, epoxy resin, melamine resin, triacetyl cellulose resin, ABS resin, AS resin, and norbornene resin), metal, wood, paper, glass, and slate, and to a hard-coating cured film showing only a small amount of curling and exhibiting excellent flexibility and chemical resistance.

In recent years, a curable composition exhibiting excellent applicability and capable of forming a cured film with excellent hardness, flexibility, scratch resistance, abrasion resistance, low curling properties (cured film shows only a small amount of warping), adhesion, transparency, chemical resistance, and appearance on a substrate has been demanded as a protective coating material for preventing scratches or stains on the surface of a substrate; an adhesive or a sealing material for a substrate; and a binder material for printing ink.

In antireflective film applications such as for film-type liquid crystal elements, touch panels, or plastic optical parts, a curable composition capable of forming a cured film having a high refractive index has been demanded.

In order to satisfy such demands, various compositions have been proposed. However, a curable composition exhibiting excellent applicability and being capable of producing a cured film exhibiting excellent hardness and flexibility and having low curling properties has not yet been obtained.

For example, a technology of using a composition containing particles obtained by modifying the surface of colloidal silica with methacryloxysilane and an acrylate as a radiation (photo) curable coating material is proposed in Published Japanese Translation of PCT International Publication No. 58-500251 this type of radiation curable composition has been widely used due to excellent applicability and the like (Japanese Patent Application Laid-open No. 10-273595, Japanese Patent Application Laid-open No. 2000-143924, Japanese Patent Application Laid-open No. 2000-281863, Japanese Patent Application Laid-open No. 2000-49077, Japanese Patent Application Laid-open No. 2001-89535 and Japanese Patent Application Laid-open No. 2001-200023).

Japanese Patent Application Laid-open No. 2003-313329 discloses a technology of reducing curling of a hard coat. However, since this technology requires a treatment temperature as high as 150° C., this technology is not suitable for film applications such as a triacetyl cellulose (TAC) film and disk applications for which heat history must not remain. This technology requires a thermal expansion capsule as an essential component, and differs in application and configuration from the present invention.

Japanese Patent Application Laid-open No. 2004-141732 discloses a cured product of a composition including a compound having an isocyanurate ring structure. However, this technology provides high hardness by increasing the film thickness without using particles.

When applying a low-refractive-index film to a cured product of the above composition and using the resulting laminate as an antireflective film, the antireflective effect is improved to a certain extent. However, the antireflective film does not exhibit well-balanced hardness, flexibility, and curling properties.

The present invention has been achieved in view of the above-described problems. An objective of the present invention is to provide a curable composition having excellent applicability which is capable of forming a coating (film) having high hardness, high flexibility, and low curling properties on the surface of various substrates, and a hard-coat cured film with excellent chemical resistance.

According to the present invention, the following curable composition, cured product, and a laminate can be provided. A curable composition, comprising: (A) 30 to 80 wt % of metal oxide particles to which an organic compound containing a polymerizable unsaturated group is bonded; and (B) 5 to 50 wt % of a urethane (meth)acrylate having an aromatic cyclic structure in the molecule and including three or more (meth)acryloyl groups, provided that the total amount of the composition excluding an organic solvent is 100 wt %.

The curable composition according to the present invention exhibits excellent applicability and is capable of forming a coating having high hardness, low curling properties, and excellent flexibility on the surface of a substrate, and a cured film including a cured product of the composition can be provided.

Embodiments of the curable composition, the cured product of the curable composition, and the laminate of the present invention are described below in detail.

I. Curable Composition

The curable composition of the present invention includes (A) 30 to 80 wt % of metal oxide particles to which an organic compound containing a polymerizable unsaturated group is bonded, and (B) 5 to 50 wt % of a urethane (meth)acrylate having an aromatic cyclic structure in the molecule and containing three or more (meth)acryloyl groups.

The components of the curable composition of the present invention are described below in detail.

1. Metal Oxide Particles (a) to which an Organic Compound Containing Polymerizable Unsaturated Group is Bonded

The component (A) used in the present invention is particles prepared by bonding (Aa) metal oxide particles and (Ab) an organic compound containing a polymerizable unsaturated group (hereinafter referred to as “reactive particles”). The components (Aa) and (Ab) may be bonded through a covalent bond or a noncovalent bond such as by physical adsorption.

(1) Metal Oxide Particles (Aa)

The metal oxide particle (Aa) used in the present invention is preferably a metal oxide particle of at least one element selected from the group consisting of silicon, aluminum, zirconium, titanium, zinc, germanium, indium, tin, antimony, and cerium, from the viewpoint of hardness and colorlessness of a cured film of the resulting curable composition.

As examples of the metal oxide particles (Aa), silica particles, alumina particles, zirconia particles, titanium oxide particles, zinc oxide particles, germanium oxide particles, indium oxide particles, tin oxide particles, antimony tin oxide (ATO) particles, indium tin oxide (ITO) particles, antimony oxide particles, cerium oxide particles, and the like can be given. Of these, silica particles, alumina particles, zirconia particles, and antimony oxide particles are preferable from the viewpoint of high hardness, with zirconia particles being particularly preferable. A high-refractive-index cured film may be obtained by using oxide particles of zirconium, titanium, or the like. A cured film may be provided with electrical conductivity by using ATO particles or the like. These particles may be used either individually or in combination of two or more. It is preferable that the oxide particles (Aa) be in the form of powder or dispersed in a liquid. When using the oxide particles (Aa) in the form of a liquid dispersion, the dispersion medium is preferably an organic solvent from the viewpoint of miscibility with other components and dispersibility of the particles. As examples of the organic solvent, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. In particular, methanol, isopropanol, butanol, methyl ethyl ketone, methyl isobutyl ketone, ethyl acetate, butyl acetate, toluene, and xylene are preferable.

The metal oxide particles (Aa) have a number average particle diameter measured by electron microscopy of preferably 0.001 to 2 μm, still more preferably 0.001 to 0.2 μm, and particularly preferably 0.001 to 0.1 μm. If the number average particle diameter exceeds 2 μm, the resulting cured product may exhibit decreased transparency, or the surface state of the resulting film may be impaired. In order to improve the dispersibility of the particles, various surfactants or amines may be added.

As commercially available products of colloidal silica (silica particles), Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like can be given. As commercially available products of powdered silica, Aerosil 130, Aerosil 300, Aerosil 380, Aerosil TT600, Aerosil OX50 (manufactured by Nippon Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), Sylysia 470 (manufactured by Fuji Silysia Chemical, Ltd.), SG Flake (manufactured by Nippon Sheet Glass Co., Ltd.), and the like can be given.

An aqueous dispersion product of alumina is commercially available as Alumina Sol-100, Alumina Sol-200, Alumina Sol-520 (manufactured by Nissan Chemical Industries, Ltd.); an isopropanol dispersion product of alumina is commercially available as AS-150I (manufactured by Sumitomo Osaka Cement Co., Ltd.); a toluene dispersion product of alumina is commercially available as AS-150T (manufactured by Sumitomo Osaka Cement Co., Ltd.); a toluene dispersion product of zirconia is commercially available as HXU-110JC (manufactured by Sumitomo Osaka Cement Co., Ltd.); an aqueous dispersion product of zinc antimonate powder is commercially available as Celnax (manufactured by Nissan Chemical Industries, Ltd.); a powder or solvent dispersion product of alumina, titanium oxide, tin oxide, indium oxide, or zinc oxide is commercially available as NanoTek (manufactured by C.I. Kasei Co., Ltd.); an aqueous dispersion sol of antimony tin oxide is commercially available as SN-100D (manufactured by Ishihara Sangyo Kaisha, Ltd.); ITO powder is commercially available from Mitsubishi Materials Corporation; and an aqueous dispersion product of cerium oxide is commercially available as Needral (manufactured by Taki Chemical Co., Ltd.).

The shape of the metal oxide particle (Aa) may be globular, hollow, porous, rod-like, plate-like, fibrous, or amorphous. The metal oxide particle (Aa) is preferably globular. The specific surface area of the metal oxide particles (Aa) (determined by BET method using nitrogen) is preferably 10 to 1000 m²/g, and still more preferably 100 to 500 m²/g. The metal oxide particles (Aa) may be used in the form of dry powder or a dispersion in water or an organic solvent. For example, a liquid dispersion of fine metal oxide particles known in the art may be used. In applications in which excellent transparency is required for the resulting cured product, it is preferable to use a liquid dispersion of the metal oxide particles.

(2) Organic Compound (Ab)

The organic compound (Ab) used in the present invention is a compound containing a polymerizable unsaturated group. The organic compound (Ab) preferably further contains a group shown by the following formula (1). The organic compound (Ab) preferably contains a group [—O—C(═O)—NH—] and at least one of groups [—O—C(═S)—NH—] and [—S—C(═O)—NH—]. The organic compound (Ab) is preferably a compound containing a silanol group in the molecule or a compound which forms a silanol group by hydrolysis. 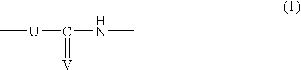
wherein U represents NH, O (oxygen atom), or S (sulfur atom), and V represents O or S.

### (i) POLYMERIZABLE UNSATURATED GROUP

There are no specific limitations to the polymerizable unsaturated group included in the organic compound (Ab). As preferable examples of the polymerizable unsaturated group, an acryloyl group, methacryloyl group, vinyl group, propenyl group, butadienyl group, styryl group, ethynyl group, cinnamoyl group, maleate group, and acrylamide group can be given.

The polymerizable unsaturated group is a structural unit, which undergoes addition polymerization in the presence of active radical species.

### (ii) GROUP SHOWN BY FORMULA (1)

The group [—U—C(═V)—NH—] shown by the formula (1) included in the organic compound is [—O—C(═O)—NH—], [—O—C(═S)—NH—], [—S—C(═O)—NH—], [—NH—C(═O)—NH—], [—NH—C(═S)—NH—], or [—S—C(═S)—NH—]. These groups may be used either individually or in combination of two or more. In particular, it is preferable to use the group [—O—C(═O)—NH—] and at least one of the groups [—O—C(═S)—NH—] and [—S—C(═O)—NH—] in combination from the viewpoint of thermal stability.

It is presumed that the group [—U—C(═V)—NH—] shown by the formula (1) causes a moderate cohesive force to occur between the molecules due to a hydrogen bond to provide the resulting cured product with properties such as excellent mechanical strength, superior adhesion to a substrate or an adjacent layer such as a high-refractive-index layer, and excellent heat resistance.

### (iii) SILANOL GROUP OR GROUP WHICH FORMS SILANOL GROUP BY HYDROLYSIS

The organic compound (Ab) is preferably a compound containing a silanol group in the molecule or a compound, which forms a silanol group by hydrolysis. As the compound which forms a silanol group, a compound in which an alkoxy group, aryloxy group, acetoxy group, amino group, halogen atom, or the like is bonded to a silicon atom can be given. In particular, a compound in which an alkoxy group or an aryloxy group is bonded to a silicon atom, specifically, a compound containing an alkoxysilyl group or a compound containing an aryloxysilyl group is preferable.

A silanol group or a silanol group-forming site of the compound, which forms a silanol group is a structural unit, which bonds to the oxide particles (Aa) by condensation or condensation occurring after hydrolysis.

### (iv) PREFERABLE EMBODIMENT

As a preferable example of the organic compound (Ab), a compound shown by the following formula (2) can be given.

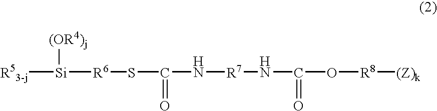

In the formula (2), R⁴ and R⁵ individually represent a hydrogen atom or an alkyl group or aryl group having 1 to 8 carbon atoms, such as a methyl group, ethyl group, propyl group, butyl group, octyl group, phenyl group, or xylyl group. j represents an integer from 1 to 3.

As examples of the group shown by [(R⁴O)ⱼR⁵₃₋ⱼSi—], a trimethoxysilyl group, triethoxysilyl group, triphenoxysilyl group, methyldimethoxysilyl group, dimethylmethoxysilyl group, and the like can be given. Of these groups, a trimethoxysilyl group or a triethoxysilyl group is preferable.

R⁶ represents a divalent organic group having an aliphatic structure or an aromatic structure having 1 to 12 carbon atoms, and may include a linear, branched, or cyclic structure. As specific examples of such an organic group, methylene, ethylene, propylene, butylene, hexamethylene, cyclohexylene, phenylene, xylylene, dodecamethylene, and the like can be given.

R⁷ represents a divalent organic group selected from divalent organic groups having a molecular weight of 14 to 10,000, and preferably 76 to 500. As specific examples of such an organic group, linear polyalkylene groups such as hexamethylene, octamethylene, and dodecamethylene; divalent alicyclic or polycyclic organic groups such as cyclohexylene and norbornylene; divalent aromatic groups such as phenylene, naphthylene, biphenylene, and polyphenylene; and alkyl-substituted products or aryl-substituted products of these groups can be given. These divalent organic groups may include an atomic group containing an element other than a carbon atom and a hydrogen atom, and may include a polyether bond, polyester bond, polyamide bond, or polycarbonate bond.

R⁸ represents an organic group with a valence of “k+1”, and is preferably selected from linear, branched, or cyclic saturated or unsaturated hydrocarbon groups.

Z represents a monovalent organic group containing a polymerizable unsaturated group, which undergoes an intermolecular crosslinking reaction in the presence of active radical species, in the molecule. k represents an integer preferably from 1 to 20, still more preferably from 1 to 10, and particularly preferably from 1 to 5.

As specific examples of the compound shown by the formula (2), compounds shown by the following formulas (4-1) and (4-2) can be given. 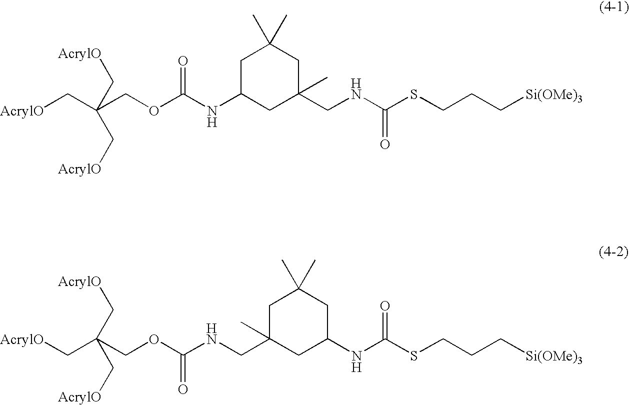
wherein “Acryl” represents an acryloyl group, and “Me” represents a methyl group.

The organic compound (Ab) used in the present invention may be synthesized by using a method disclosed in Japanese Patent Application Laid-open No. 9-100111, for example. The organic compound (Ab) is preferably produced by reacting mercaptopropyltrimethoxysilane and isophorone diisocyanate at 60 to 70° C. for several hours in the presence of dibutyltin dilaurate, adding pentaerythritol triacrylate to the reaction product, and reacting the mixture at 60 to 70° C. for several hours.

(3) Reactive Particles (A)

The organic compound (Ab) containing a silanol group or a group which forms a silanol group by hydrolysis is mixed with the metal oxide particles (Aa) and hydrolyzed to bond the metal oxide particles (Aa) and the organic compound (Ab). The amount of organic polymer component (i.e. hydrolysate and condensate of hydrolysable silane) in the resulting reactive particles (A) may be determined, by thermogravimetric analysis from room temperature to 800° C. in air, as a constant weight loss (%) when completely burning the dry powder in air, for example.

The amount of the organic compound (Ab) bonded to the oxide particles (Aa) is preferably 0.01 wt % or more, still more preferably 0.1 wt % or more, and particularly preferably 1 wt % or more of 100 wt % of the reactive particles (A) (metal oxide particles (Aa) and organic compound (Ab) in total). If the amount of the organic compound (Ab) bonded to the metal oxide particles (Aa) is less than 0.01 wt %, the dispersibility of the reactive particles (A) in the composition may be insufficient, whereby the resulting cured product may exhibit insufficient transparency and scratch resistance. The amount of the metal oxide particles (Aa) in the raw material when preparing the reactive particles (A) is preferably 5 to 99 wt %, and still more preferably 10 to 98 wt %.

The amount (content) of the reactive particles (A) in the curable composition must be 30 to 80 wt %, and is preferably 40 to 60 wt % for 100 wt % of the total amount of the composition excluding an organic solvent. If the amount is less than 30 wt %, the resulting cured product may exhibit insufficient hardness or may have a low refractive index. If the amount exceeds 80 wt %, film formability may be insufficient. In this case, the oxide particles (Aa) preferably account for 65 to 95 wt % of the reactive particles (A). The amount of the reactive particles (A) refers to the solid content. When the reactive particles (A) are used in the form of liquid dispersion, the amount of the reactive particles (A) excludes the amount of dispersion medium.

2. Urethane (Meth)Acrylate (B) Having Aromatic Cyclic Structure in the Molecule and Containing Three or More (Meth)Acryloyl Groups

The component (B) is a urethane (meth)acrylate having an aromatic cyclic structure in the molecule and containing three or more (meth)acryloyl groups. The number of (meth)acryloyl groups is preferably six or more, and still more preferably eight or more. The component (B) reduces curling of a cured product produced by curing the curable composition of the present invention while maintaining the hardness of the cured product.

The addition of the component (B) increases the distance between crosslinking points to reduce the amount of curling. Moreover, since a urethane (meth)acrylate having an aromatic cyclic structure has crystallinity, the mechanical strength and toughness are improved so that hardness can be maintained even if the distance between crosslinking points is increased.

The aromatic cyclic structure in the compound as the component (B) is not particularly limited. As the aromatic cyclic structure, a benzene ring, condensed benzene rings such as a naphthalene ring, anthracene ring, phenanthrene ring, indene ring, and pyrene ring, heteroaromatic rings such as a thiophene ring, pyrrole ring, furan ring, and pyridine ring, and the like are preferable.

The component (B) has a molecular weight per (meth)acryloyl group of preferably 400 or less, and still more preferably 300 or less. If the molecular weight per (meth)acryloyl group of preferably 400 or less, scratch resistance is improved.

As a compound preferable as the component (B), a compound shown by the following formula (3) (hereinafter called “PTP”) can be given.

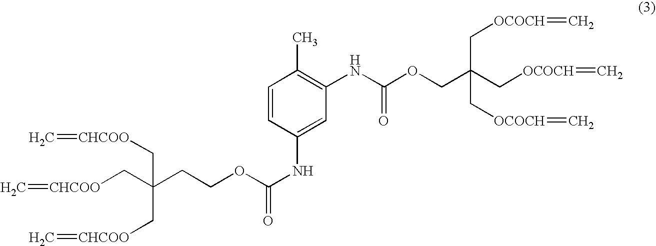

The compound shown by the formula (3) may be obtained by stirring a diisocyanate having an aromatic ring and a (meth)acrylic compound containing a hydroxyl group at 60° C. for six hours in the presence of an appropriate urethanization catalyst.

As examples of the diisocyanate having an aromatic ring, 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 6-isopropyl-1,3-phenyl diisocyanate, -diphenylpropane diisocyanate, tetramethylxylylene diisocyanate, and the like can be given. Of these, 2,4-tolylene diisocyanate and the like are particularly preferable.

As specific examples of the (meth)acrylic compound containing a hydroxyl group, 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylates shown by the following formulas (6-1) and (6-2), a compound obtained by the addition reaction of (meth)acrylic acid with a glycidyl group-containing compound such as alkyl glycidyl ether, allyl glycidyl ether, or glycidyl (meth)acrylate, and the like can be given. 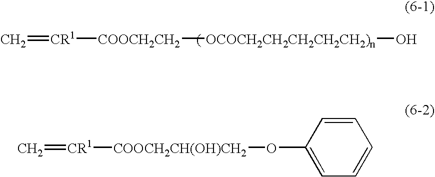
wherein R¹ represents a hydrogen atom or a methyl group, and n represents an integer from 1 to 15. Of these, pentaerythritol tri(meth)acrylate and the like are preferable.

As specific examples of the urethanization catalyst, copper naphthenate, cobalt naphthenate, zinc naphthenate, dibutyl tin dilaurate, triethylamine, 1,4-diazabicyclo[2.2.2]octane, 2,6,7-trimethyl-1,4-diazabicyclo[2.2.2]octane, and the like can be given. Of these, dibutyltin dilaurate and the like are preferable.

The content of the component (B) in the curable composition of the present invention is 5 to 50 wt %, still more preferably 10 to 40 wt %, and still more preferably 20 to 40 wt % for 100 wt % of the total amount of the composition excluding an organic solvent. If the content of the component (B) is less than 5 wt %, the effect of addition may not be obtained. If the content of the component (B) exceeds 50 wt %, the resulting coating may exhibit insufficient mechanical strength.

3. Compound (C) Containing Two or More Polymerizable Unsaturated Groups in the Molecule Other than Component (B)

The composition of the present invention may include (C) a compound containing two or more polymerizable unsaturated groups in the molecule other than component (B), as required. The component (C) is not particularly limited. The component (C) is preferably a polyfunctional (meth)acrylate.

The compound (C) is suitably used to improve the flexibility of the resulting cured film.

The polyfunctional (meth)acrylate compound as the compound (C) may be a (meth)acrylate monomer containing two or more polymerizable unsaturated groups in the molecule. The polyfunctional (meth)acrylate compound is suitably used to improve the curability and hardness of the resulting cured film. The expression “polyfunctional” used herein means that the (meth)acrylate compound contains two or more (meth)acryloyl groups in the molecule. From the viewpoint of film formability and hardness, a tri- or higher functional (meth)acrylate compound is preferable, with a penta- or higher functional (meth)acrylate compound being still more preferable.

As preferable examples of the polyfunctional (meth)acrylate compound, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, poly(meth)acrylates of ethylene oxide or propylene oxide addition product of starting alcohols of these (meth)acrylates, oligoester (meth)acrylates, oligoether (meth)acrylates, and oligoepoxy (meth)acrylates having two or more (meth)acryloyl groups in the molecule, and the like can be given. Of these, dipentaerythritol hexa(meth)acrylate, dipentaerythritol penta(meth)acrylate, pentaerythritol tetra(meth)acrylate, and ditrimethylolpropane tetra(meth)acrylate are preferable.

As commercially available products of the polyfunctional (meth)acrylate compound, Nikalac MX-302 (manufactured by Sanwa Chemical Co., Ltd.), Aronix M-400, M-402, M-403, M-404, M-408, M-450, M-305, M-309, M-310, M-313, M-315, M-320, M-325, M-326, M-327, M-350, M-360, M-208, M-210, M-215, M-220, M-225, M-233, M-240, M-245, M-260, M-270, M-1100, M-1200, M-1210, M-1310, M-1600, M-221, M-203, TO-924, TO-1270, TO-1231, TO-595, TO-756, TO-1343, TO-1382, TO-902, TO-904, TO-905, TO-1330 (manufactured by Toagosei Co., Ltd.); Kayarad D-310, D-330, DPHA, DPCA-20, DPCA-30, DPCA-60, DPCA-120, DN-0075, DN-2475, SR-295, SR-355, SR-399E, SR-494, SR-9041, SR-368, SR-415, SR-444, SR-454, SR-492, SR-499, SR-502, SR-9020, SR-9035, SR-111, SR-212, SR-213, SR-230, SR-259, SR-268, SR-272, SR-344, SR-349, SR-368, SR-601, SR-602, SR-610, SR-9003, PET-30, T-1420, GPO-303, TC-120S, HDDA, NPGDA, TPGDA, PEG400DA, MANDA, HX-220, HX-620, R-551, R-712, R-167, R-526, R-551, R-712, R-604, R-684, TMPTA, THE-330, TPA-320, TPA-330, KS-HDDA, KS-TPGDA, KS-TMPTA (manufactured by Nippon Kayaku Co., Ltd.); Light Acrylate PE-4A, DPE-6A, DTMP-4A (manufactured by Kyoeisha Chemical Co., Ltd.); and the like can be given. The above compounds may be used either individually or in combination of two or more.

As the component (C), a urethane (meth)acrylate containing at least two (meth)acryloyl groups other than the component (B) may be used in addition to the above polyfunctional (meth)acrylate.

The urethane (meth)acrylate may be basically obtained by reacting (a) a polyisocyanate compound and (b) a hydroxyl group-containing (meth)acrylate monomer. The urethane (meth)acrylate may be a urethane compound containing another oligomer as the main chain.

The urethane (meth)acrylate has at least two, preferably four or more, and still more preferably six or more (meth)acryloyl groups. Such a urethane (meth)acrylate usually has a structure in which the hydroxyl group-containing (meth)acrylate monomer (b) is bonded to each isocyanate group of the polyisocyanate compound (a) having 2 to 6 isocyanate groups.

A urethane (meth)acrylate shown by the following formula (7) can improve the flexibility and anti-curling properties of the resulting cured film without affecting the hardness of the cured film to a large extent. 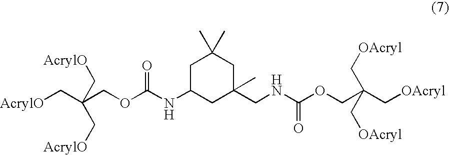
wherein “Acryl” represents an acryloyl group.

As commercially available products of the urethane (meth)acrylate used in the present invention, Beamset 102, 502H, 505A-6, 510, 550B, 551B, 575, 575CB, EM-90, EM92 (manufactured by Arakawa Chemical Industries, Ltd.), Photomer 6008, 6210 (manufactured by San Nopco, Ltd.), NK Oligo U-2PPA, U-4HA, U-6HA, H-15HA, UA-32PA, U-324A, U-4H, U-6H (manufactured by Shin-Nakamura Chemical Co., Ltd.), Aronix M-1100, M-1200, M-1210, M-1310, M-1600, M-1960 (manufactured by Toagosei Co., Ltd.), AH-600, AT606, UA-306H (manufactured by Kyoeisha Chemical Co., Ltd.), Kayarad UX-2201, UX-2301, UX-3204, UX-3301, UX-4101, UX-6101, UX-7101 (manufactured by Nippon Kayaku Co., Ltd.), UV-1700B, UV-3000B, UV-6100B, UV-6300B, UV-7000, UV-2010B (manufactured by Nippon Synthetic Chemical Industry Co., Ltd.), Art Resin UN-1255, UN-5200, HDP-4T, HMP-2, UN-901T, UN-3320HA, UN-3320HB, UN-3320HC, UN-3320HS, H-61, HDP-M20 (manufactured by Negami Chemical Industrial Co., Ltd.), Ebecryl 6700, 204, 205, 220, 254, 1259, 1290K, 1748, 2002, 2220, 4833, 4842, 4866, 5129, 6602, 8301 (manufactured by Daicel UBC Co., Ltd.), and the like can be given. Of these, U-6HA is preferable as a urethane (meth)acrylate containing three or more (meth)acrylate groups.

The component (C) is used in the present invention in an amount of preferably 0 to 40 wt %, and still more preferably 0 to 35 wt % for 100 wt % of the total amount of the composition excluding an organic solvent. If the amount is 0 to 40 wt %, the resulting cured film is expected to exhibit improved flexibility and anti-curling properties.

4. Radical Polymerization Initiator (D)

The composition of the present invention may include (D) a radical polymerization initiator, as required.

As examples of the radical polymerization initiator (D), a compound which thermally generates active radical species (heat polymerization initiator), and a compound which generates active radical species upon application of radiation (light) (radiation (photo) polymerization initiator) can be given.

There are no specific limitations to the radiation (photo) polymerization initiator insofar as the initiator decomposes upon irradiation and generates radicals to initiate polymerization. Examples of the radiation (photo) polymerization initiator include acetophenone, acetophenone benzyl ketal, 1-hydroxycyclohexyl phenyl ketone, 2,2-dimethoxy-1,2-diphenylethan-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2-benzyl-2-dimethylamino-1-(4-morpholinophenyl)-butanone-1,4-(2-hydroxyethoxy)phenyl-(2-hydroxy-2-propyl)ketone, 2,4,6-trimethylbenzoyl diphenylphosphine oxide, bis-(2,6-dimethoxybenzoyl)-2,4,4-trimethylpentylphosphine oxide, oligo(2-hydroxy-2-methyl-1-(4-(1-methylvinyl)phenyl)propanone), and the like.

As commercially available products of the radiation (photo) polymerization initiator, Irgacure 184, 369, 651, 500, 819, 907, 784, 2959, CGI1700, CGI1750, CGI1850, CG24-61, Darocur 1116, 1173 (manufactured by Ciba Specialty Chemicals Inc.), Lucirin TPO (manufactured by BASF), Ebecryl P36 (manufactured by UCB), Esacure KIP150, KIP65LT, KIP100F, KT37, KT55, KTO46, KIP75/B (manufactured by Lamberti), and the like can be given.

The radical polymerization initiator (D), which is used in the present invention as an optional component, is used in an amount of preferably 0.01 to 10 wt %, and still more preferably 0.1 to 10 wt % for 100 wt % of the total amount of the composition excluding an organic solvent. If the amount is less than 0.01 wt %, the resulting cured product may exhibit insufficient hardness. If the amount exceeds 10 wt %, the inside (lower layer) of the cured product may remain uncured.

When curing the composition of the present invention, a photoinitiator and a heat polymerization initiator may be used in combination, as required.

As preferable examples of the heat polymerization initiator, peroxides and azo compounds can be given. Specific examples include benzoyl peroxide, t-butyl peroxybenzoate, azobisisobutyronitrile, and the like.

5. Organic Solvent (E)

The composition of the present invention may be diluted with (E) an organic solvent in order to adjust the thickness of a coating formed by using the composition. In the case where the composition is used as an antireflective film or a coating material, the viscosity of the composition is usually 0.1 to 50,000 mPa·s/25° C., and preferably 0.5 to 10,000 mPa·s/25° C.

As specific examples of the organic solvent (E), alcohols such as methanol, ethanol, isopropanol, butanol, and octanol; ketones such as acetone, methyl ethyl ketone (MEK), methyl isobutyl ketone (MIBK), methyl amyl ketone (MAK), and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether, diethylene glycol monobutyl ether, and propylene glycol monomethyl ether; aromatic hydrocarbons such as benzene, toluene, and xylene; amides such as dimethylformamide, dimethylacetamide, and N-methylpyrrolidone; and the like can be given. Of these, high-boiling solvents such as methyl ethyl ketone (MEK), methyl isobutyl ketone (MIBK), cyclohexanone, propylene glycol monomethyl ether acetate, propylene glycol monoethyl ether acetate, propylene glycol monomethyl ether, toluene, and xylene are preferable.

The organic solvent (E) is used in the composition of the present invention in an amount of usually 30 to 60 wt %, and preferably 40 to 60 wt % of the total amount of the composition. If the amount of the organic solvent (E) is 30 to 60 wt %, the composition exhibits excellent applicability.

6. Other Components

The curable composition of the present invention may include a photosensitizer, polymerization inhibitor, polymerization adjuvant, leveling agent, wettability improver, surfactant, plasticizer, UV absorber, antioxidant, antistatic agent, inorganic filler, pigment, dye, or the like insofar as the effects of the present invention are not impaired.

7. Preparation of Composition

The composition of the present invention is prepared as follows. A reaction vessel equipped with a stirrer is charged with a reactive particle liquid dispersion (component (A)), a radiation (photo) polymerization initiator (component (D)), a polyfunctional (meth)acrylate (component (C)), a urethane (meth)acrylate having an aromatic cyclic structure (component (B)), and a urethane (meth)acrylate (component (C)). The mixture is stirred at 35 to 45° C. for two hours to obtain the composition of the present invention.

When replacing the solvent with a solvent (B) differing from a solvent (A) used in the reactive particle liquid dispersion, the solvent (B) is also added to the mixture in the same amount as the amount of the solvent (A) of the reactive particle liquid dispersion, and the mixture is stirred under the same conditions. The composition solution is concentrated under reduced pressure by using a rotary evaporator until the solid content reaches 50% to obtain the composition of the present invention.

8. Application (Coating) of Composition

The curable composition of the present invention is suitable for use as an antireflective film or a coating material. As examples of substrates to which the composition is applied, plastic (e.g. polycarbonate, polymethacrylate, polystyrene, polyester, polyolefin, epoxy resin, melamine resin, triacetyl cellulose resin, ABS resin, AS resin, and norbornene resin), metal, wood, paper, glass, slate, and the like can be given. The substrate may be in the shape of a plate, a film, or a three-dimensional formed product. As the coating method, an ordinary coating method such as dipping, spray coating, flow coating, shower coating, roll coating, spin coating, or brush coating can be given. The thickness of the coating after drying and curing is usually 0.1 to 400 μm, and preferably 1 to 200 μm.

9. Curing of Composition

The curable composition of the present invention may be cured by applying heat and/or radiation (light). When curing the composition by applying heat, an electric heater, infrared lamp, hot blast, or the like may be used as the heat source. When curing the composition by applying radiation (light), there are no specific limitations to the radiation source insofar as the composition can be cured in a short period of time after application. As examples of the source of infrared rays, a lamp, resistance heating plate, laser, and the like can be given. As examples of the source of visible rays, sunlight, a lamp, fluorescent lamp, laser, and the like can be given. As examples of the source of ultraviolet rays, a mercury lamp, halide lamp, laser, and the like can be given. As examples of the source of electron beams, a system utilizing thermoelectrons generated from a commercially available tungsten filament, a cold cathode method which generates electron beams by applying a high voltage pulse through a metal, and a secondary electron method which utilizes secondary electrons generated by collision between ionized gaseous molecules and a metal electrode can be given. As examples of the sources of α-rays, β-rays, and γ-rays, fissionable substances such as Co⁶⁰ and the like can be given. As the source of α-rays, a vacuum tube which causes accelerated electrons to collide with an anode or the like may be utilized. The radiation may be used either individually or in combination of two or more types. In the latter case, two or more types of radiation may be applied either simultaneously or at certain intervals of time.

The curing reaction of the composition of the present invention may be carried out in air or under anaerobic conditions such as in a nitrogen atmosphere. Even when the composition of the present invention is cured under anaerobic conditions, the resulting cured product exhibits excellent scratch resistance.

II. Cured Layer

A cured layer of the present invention may be obtained by applying the curable composition to a substrate such as a plastic substrate, and curing the applied composition. In more detail, the composition is applied to a substrate, and volatile components are dried at a temperature of preferably 0 to 200° C. Then, the composition is cured by applying heat and/or radiation as described above to obtain a coating formed product. When curing the composition by applying heat, the composition is preferably cured at 20 to 150° C. for 10 seconds to 24 hours. When curing the composition by applying radiation, it is preferable to use ultraviolet rays or electron beams. In this case, the dose of ultraviolet rays is preferably 0.01 to 10 J/cm², and still more preferably 0.1 to 2 J/cm². Electron beams are preferably applied at an accelerating voltage of 10 to 300 KV, an electron density of 0.02 to 0.30 mA/cm², and a dose of 1 to 10 Mrad.

Since the cured layer of the present invention can form a coating (film) having high hardness, showing only a small amount of curling after immersion in hot water, and exhibiting excellent scratch resistance and excellent adhesion to a substrate or an adjacent layer such as a low-refractive-index layer, the cured film is particularly suitable as an antireflective film for film-type liquid crystal elements, touch panels, plastic optical parts, and the like.

III. Laminate

The cured layer of the present invention is usually laminated on a substrate as a hard coating layer. A laminate suitable as an antireflective film may be formed by laminating a high-refractive-index layer and a low-refractive-index layer on the cured film (hard coating layer). The antireflective film may further include another layer. For example, pairs of a high-refractive-index layer and a low-refractive-index layer may be provided to form a wide-band antireflective film having relatively uniform reflectance characteristics for light over a wide wavelength range. Or, an antistatic layer may be provided.

There are no specific limitations to the substrate. When using the laminate as an antireflective film, plastic (e.g. polycarbonate, polymethyl methacrylate, polystyrene, polyester, polyolefin, epoxy resin, melamine resin, triacetyl cellulose (TAC) resin, ABS resin, AS resin, and norbornene resin) and the like can be given as the material for the substrate.

As the high-refractive-index film used for the laminate of the invention, a coating material cured film having a refractive index of 1.65 to 2.20 and containing metal oxide particles such as zirconia particles can be given, for example.

As examples of the low-refractive-index film used in the present invention, a film having a refractive index of 1.38 to 1.45, such as a metal oxide film or a fluorine-type coating material cured film containing magnesium fluoride or silicon dioxide, can be given.

A cured product of the present invention obtained by applying the curable composition of the present invention to a substrate and curing the applied composition by applying ultraviolet rays shows only a small amount of curling, exhibits excellent flexibility and haze properties, and has high hardness.

It is estimated that the cured layer of the invention shows only a small amount of curling because the addition of the polyfunctional urethane (meth)acrylate (B) having an aromatic cyclic structure in the molecule increases the distance between crosslinking points to reduce the amount of curling. Moreover, since a urethane (meth)acrylate having an aromatic cyclic structure has crystallinity, the mechanical strength and toughness are improved so that hardness can be maintained even if the distance between crosslinking points is increased.

As a method of forming the low-refractive-index film on the high-refractive-index cured film obtained by curing the curable composition, vacuum deposition, sputtering, and the like can be given when forming a metal oxide film. When forming a fluorine-type coat material cured film, the above-described composition application (coating) method may be used.

Reflection of light on the surface of the substrate can be effectively prevented by layering the high-refractive-index cured film and the low-refractive-index film on the substrate.

Since the laminate of the present invention has excellent scratch resistance, low reflectance, and excellent chemical resistance, the laminate is particularly suitably used as an antireflective film for film-type liquid crystal elements, touch panels, plastic optical parts, and the like.

### EXAMPLES

The present invention is described below in detail by way of examples. However, the scope of the present invention is not limited to the following examples. In the examples, “part” refers to “part by weight” and “%” refers to “wt %” unless otherwise indicated.

### Preparation Example 1

### Preparation of Organic Compound (Ab) Containing Polymerizable Unsaturated Group

222 parts of isophorone diisocyanate was added dropwise to a solution of 221 parts of mercaptopropyltrimethoxysilane and I part of dibutyltin dilaurate in dry air at 50° C. in one hour with stirring. The mixture was then stirred at 70° C. for three hours. After the dropwise addition of 549 parts of NK Ester A-TMM-3LM-N (manufactured by Shin-Nakamura Chemical Co., Ltd.; consisting of 60 wt % of pentaerythritol triacylate and 40 wt % of pentaerythritol tetraacrylate; only pentaerythritol triacylate containing hydroxyl group takes part in the reaction) at 30° C. in one hour, the mixture was stirred at 60° C. for 10 hours to obtain an organic compound (Ab) containing a polymerizable unsaturated group. The residual isocyanate content in the product analyzed by FT-IR was 0.1% or less. This indicates that the reaction completed almost quantitatively. In the infrared absorption spectrum of the product, the absorption peak at 2550 kayser characteristic of a mercapto group in the raw material and the absorption peak at 2260 kayser characteristic of the raw material isocyanate compound disappeared, and the absorption peak at 1660 kayser characteristic of a urethane bond and an S(C═O)NH— group and the absorption peak at 1720 kayser characteristic of an acryloxy group appeared. This indicates that an acryloxy group-modified alkoxysilane containing an acryloxy group, —S(C═O)NH— group, and urethane bond was produced. The above reaction yielded 773 parts of compounds shown by the formulas (4-1) and (4-2). The product also contained 220 parts of pentaerythritol tetraacrylate which did not take part in the reaction.

### Preparation Example 2

### Preparation of Urethane (Meth)Acrylate (C-5) (Compound Shown by Formula (7))

A vessel equipped with a stirrer was charged with a solution of 18.8 parts of isophorone diisocyanate and 0.2 parts of dibutyltin dilaurate. After the dropwise addition of 93 parts of NK Ester A-TMM-3LM-N (manufactured by Shin-Nakamura Chemical Co., Ltd.; only pentaerythritol triacylate containing hydroxyl group takes part in the reaction) at 10° C. in one hour, the mixture was stirred at 60° C. for six hours to obtain a reaction liquid.

The residual isocyanate content in the reaction liquid measured by FT-IR in the same manner as in Preparation Example 1 was 0.1 wt % or less. This indicates that the reaction was completed almost quantitatively. It was confirmed that a urethane bond and an acryloyl group (polymerizable unsaturated group) were included in the molecule.

The above reaction yielded 75 parts of a compound shown by the formula (7). The product also contained 37 parts of pentaerythritol tetraacrylate which did not take part in the reaction.

### Preparation Example 3

### Preparation of Fine Reactive Silica Particle Sol (A-1)

A mixed solution of a mixture of 8.1 parts of the organic compound (Ab) containing a polymerizable unsaturated group prepared in Preparation Example 1 and pentaerythritol tetraacrylate, 91.3 parts of silica particle sol (methyl ethyl ketone silica sol, “MEK-ST” manufactured by Nissan Chemical Industries, Ltd., number average particle diameter: 0.022 μm, and silica content: 30%) (27 parts as silica particles), and 0.1 part of ion-exchanged water was stirred at 60° C. for three hours. After the addition of 1.4 parts of methyl orthoformate, the mixture was stirred at 60° C. for one hour to obtain reactive particles (liquid dispersion (A-1)). 2 g of the liquid dispersion (A-1) was weighed on an aluminum dish and dried on a hot plate at 175° C. for one hour. The dried product was weighed to indicate that the solid content was 35%.

### Preparation Example 4

### Preparation of Urethane (Meth)Acrylate (B-1) (Compound Shown by Formula (3))

A vessel equipped with a stirrer was charged with a solution of 14.7 parts of 2,4-tolylene diisocyanate and 0.2 parts of dibutyltin dilaurate. After the dropwise addition of 93 parts of NK Ester A-TMM-3LM-N (manufactured by Shin-Nakamura Chemical Co., Ltd) (only pentaerythritol triacylate having hydroxyl group takes part in the reaction) at 10° C. in one hour, the mixture was stirred at 60° C. for six hours to obtain a reaction liquid.

The residual isocyanate content in the reaction liquid measured by FT-IR in the same manner as in Preparation Example 1 was 0.1 wt % or less. This indicates that the reaction was completed almost quantitatively. It was confirmed that a urethane bond and an acryloyl group (polymerizable unsaturated group) were included in the molecule.

The above reaction yielded 71 parts of a compound shown by the formula (3). The product also contained 37 parts of pentaerythritol tetraacrylate which did not take part in the reaction.

### Example 1

A vessel shielded from ultraviolet rays was charged with 169.1 parts of the reactive silica particle sol (A-1) prepared in Preparation Example 3 (reactive silica: 54.34 parts), 6.27 parts of the urethane (meth)acrylate (C-5) prepared in Preparation Example 2, 15.06 parts of pentaerythritol tetraacrylate (C-3), 20.56 parts of the urethane (meth)acrylate (B-1) prepared in Preparation Example 4, and 114.76 parts of methyl isobutyl ketone (MIBK). The mixture was stirred at 30° C. for two hours to obtain a homogeneous solution. The solution was concentrated under reduced pressure to remove 129.52 parts of volatile components. Then, 2.36 parts of 1-hydroxycyclohexyl phenyl ketone (D-1) and 1.41 parts of 2-methyl-1-[4-(methylthio)phenyl]-2-morpholinopropanon-1 (D-2) to obtain a composition. The pentaerythritol tetraacrylate (C-3) originates in pentaerythritol tetraacrylate in the organic compound (Ab) and the urethane (meth)acrylates (B-1) and (C-5). The solid content of the composition measured in the same manner as in Preparation Example 3 was 50%.

### Examples 2 to 5 and Comparative Examples 1 to 3

Compositions of Examples 2 to 5 and Comparative Examples 1 to 3 were prepared in the same manner as in Example 1 except for changing the composition as shown in Table 1.

Evaluation of Properties of Hard Coating Layer

The composition obtained in each of Examples 1 to 5 and Comparative Examples 1 to 3 was applied to a TAC film by using a coater equipped with a wire bar coater (#40) appropriate for the film thickness, and dried at 100° C. for one minute in an oven to form a coating. The coating was cured by applying ultraviolet rays in air at a dose of 0.3 J/cm² by using a high-pressure mercury lamp to form a TAC film provided with a hard coating having a thickness of 20 μm. The following properties (1) to (4) of the TAC film provided with a hard coating were evaluated.

(1) Curling

The resulting TAC film provided with a hard coating was cut into a square with a size of 10×10 cm and placed on a horizontal plane. The average value of the distances of the four corners from the horizontal plane was taken as the amount of curling.

(2) Flexibility

The resulting TAC film provided with a hard coating was cut into a size of 10×1 cm, and wound around a metal rod. The minimum diameter of the metal rod at which occurrence of cracks was not observed with the naked eye was taken as the evaluation value.

(3) Haze (%)

The haze value of the TAC film provided with a high-refractive-index film was measured according to JIS K 7105 by using a color haze meter (manufactured by Suga Test Instruments Co., Ltd.).

(4) Pencil Hardness

The TAC film was scratched five times at a load of 500 g by using a pencil hardness tester. The hardness of a pencil by which the TAC film was not damaged four times or more was taken as the evaluation value.

(5) Universal Hardness

The composition obtained in each of Examples 1 to 5 and Comparative Examples 1 to 3 was applied to a slide by using a coater equipped with a wire bar coater (#40) appropriate for the film thickness, and dried at 80° C. for one minute in an oven to form a coating. The coating was cured by applying ultraviolet rays in air at a dose of 0.3 J/cm² by using a high-pressure mercury lamp to form a slide provided with a hard coating having a thickness of 20 μm. The universal hardness of the resulting specimen was measured by using a Fischerscope H100 microhardness meter under conditions given below.

Indenter: Vickers square pyramid diamond indenter

Maximum load: 300 mN, loading speed: 300 mN/60 sec

TABLE 1

| | | | | | | | | Comparative | | |
|---|---|---|---|---|---|---|---|---|---|---|
| | | | Example | | | | | Example | | |
| Amount (wt %) | | | 1 | 2 | 3 | 4 | 5 | 1 | 2 | 3 |
| Composition | (A) | Reactive silica particles (A-1) | 54.34 | 43.05 | 42.38 | 42.38 | 42.38 | 41.28 | 41.28 | 42.38 |
| | (B) | Compound shown by the formula (3) (B-1) | 20.56 | 29.43 | 25.06 | 22.12 | 22.12 | — | — | 2.95 |
| | (C) | Dipentaerythritol tetracylate (C-1) | — | — | 6.73 | 11.22 | — | 46.07 | — | — |
| | | Isocyanuric acid EO-modified triacylate (C-2) | — | — | — | — | 11.22 | — | — | 40.38 |
| | | Pentaerythritol tetraacrylate (C-3) | 15.06 | 18.78 | 16.47 | 14.92 | 14.92 | 3.3 | 3.3 | 4.93 |
| | | Trimethylolpropane EO-modified triacylate (C-4) | — | — | — | — | — | — | 46.07 | — |
| | | Compound shown by the formula (7) (C-5) | 6.27 | 4.97 | 4.89 | 4.89 | 4.89 | 4.76 | 4.76 | 4.89 |
| | (D) | 1-Hydroxycyclohexyl phenyl ketone (D-1) | 2.36 | 2.36 | 2.79 | 2.79 | 2.79 | 2.87 | 2.87 | 2.79 |
| | | 2-Methyl-1-[4-(methylthio)phenyl]- | 1.41 | 1.41 | 1.68 | 1.68 | 1.68 | 1.72 | 1.72 | 1.68 |
| | | 2-morpholinopropanone-1 (D-2) | | | | | | | | |
| | Total of (A) to (D) | | 100 | 100 | 100 | 100 | 100 | 100 | 100 | 100 |
| | (E) | Methyl isobutyl ketone | 90 | 90 | 90 | 90 | 90 | — | — | 90 |
| | | Methy ethyl ketone | 10 | 10 | 10 | 10 | 10 | 100 | 100 | 10 |

| | Solid content (wt %) | 50 | 50 | 50 | 50 | 50 | 50 | 50 | 50 |
|---|---|---|---|---|---|---|---|---|---|
| Cured film | (1) Curling (mm) | 5 | 9 | 8 | 16 | 7 | ≧30 | 20 | 6 |
| | (2) Flexibility (mm) | 13 | 13 | 13 | 14 | 13 | ≧30 | 4 | 10 |
| | (3) Haze (%) | 0 | 0.1 | 0 | 0 | 0 | 0 | 0 | 0 |
| | (4) Pencil hardness | 4H | 4H | 4H | 4H | 4H | 4H | H | 3H |
| | (5) Universal hardness (mN/mm²) | 395 | 360 | 390 | 403 | 355 | 450 | 290 | 335 |

In Table 1, the amount of the reactive silica particles (A-1) indicates the fine powder dry weight (excluding organic solvent).

The details of the compounds shown in Table 1 are given below. Reactive silica particles (A-1): reactive silica particles obtained in Preparation Example 3

PTP (B-1): compound shown by formula (3) obtained in Preparation Example 4

Dipentaerythritol triacylate (C-1): “Aronix M-404” manufactured by Toagosei Co., Ltd.

Isocyanuric acid EO-modified triacylate (C-2): “Aronix M-315” manufactured by Toagosei Co., Ltd.

Trimethylolpropane EO-modified triacylate (C-4): “A-TMPT-3EO” manufactured by Shin-Nakamura Chemical Co., Ltd.

1-Hydroxycyclohexyl phenyl ketone (D-1): Irgacure 184 manufactured by Ciba Specialty Chemicals Co., Ltd.

2-Methyl-1-[4-(methylthio)phenyl]-2-morpholinopropanone-1 (D-2): Irgacure 907 manufactured by Ciba Specialty Chemicals Co., Ltd.

MIBK: Methyl isobutyl ketone

MEK: Methyl ethyl ketone

From the results shown in Table 1, the cured film of the example shows only a small amount of curling and exhibits well-balanced flexibility and hardness.

On the other hand, the cured film of Comparative Examples 1 and 2, which do not contain the component (B) of the present invention, show a large amount of curling. In Comparative Example 1, while the pencil hardness and the universal hardness are high, the flexibility is decreased. In Comparative Example 2, while the flexibility is excellent, the pencil hardness and the universal hardness are decreased. In Comparative Example 3 in which the amount of the component (B) is small, the pencil hardness and the universal hardness are decreased to a small extent.

As described above, the curable composition and the cured product of the present invention can be suitably used as a protective coating material for preventing occurrence of scratches or stains of plastic optical parts, touch panels, film-type liquid crystal elements, plastic containers, and flooring materials, wall materials, and artificial marbles used as architectural interior finish; an antireflective film for film-type liquid crystal elements, touch panels, or plastic optical parts; an adhesive or a sealing material for various substrates; a binder for printing ink; and the like. The curable composition and the cured product can be particularly suitably used as an antireflective film.

The curable composition and the cured product of the present invention are particularly suitable as an antireflective film, an optical film hard coating for a touch panel, and an optical disk hard coating.

1. A curable composition, comprising: (A) 30 to 80 wt % of metal oxide particles to which an organic compound containing a polymerizable unsaturated group is bonded; and (B) 5 to 50 wt % of a urethane (meth)acrylate having an aromatic cyclic structure in the molecule and including three or more (meth)acryloyl groups, provided that the total amount of the composition excluding an organic solvent is 100 wt %.

2. The curable composition according to claim 1, wherein the organic compound in the particle of the component (A) contains a group shown by the following formula (1) in addition to the polymerizable unsaturated group, 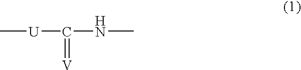
wherein U represents NH, O (oxygen atom), or S (sulfur atom), and V represents O or S.

3. The curable composition according to claim 1, wherein the organic compound in the particle of the component (A) is a compound containing a silanol group in the molecule or a compound which forms a silanol group by hydrolysis.

4. The curable composition according to claim 1, wherein the component (B) has a molecular weight of 400 or less per (meth)acryloyl group.

5. The curable composition according to claim 1, wherein the urethane (meth)acrylate having an aromatic cyclic structure in the molecule and containing three or more (meth)acryloyl groups of the component (B) is a compound shown by the following formula (3):

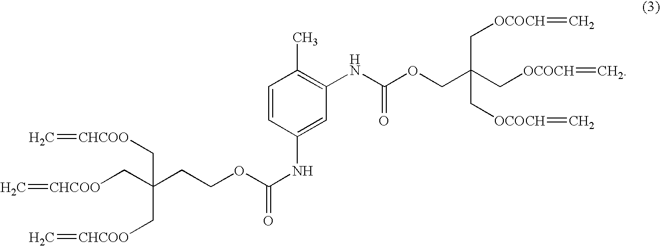

6. A cured layer produced by curing the curable composition according to claim 1.

7. A laminate, comprising a transparent substrate and the cured layer according to claim 6 provided on the transparent substrate.

8. An antireflective film, comprising a transparent substrate, the cured layer according to claim 6, and a low-refractive-index layer which are layered in that order.
